(19) United States
(12) Patent Application Publication
(10) Pub. No.: US 2003/0154286 A1
(43) Pub. Date: Aug. 14, 2003

(54) System for and method of protecting a username during authentication over a non-encrypted channel

(75) Inventors: Victor Tang, Vancouver (CA); David Rowley, Burnaby (CA)

Correspondence Address: FOLEY & LARDNER, 777 EAST WISCONSIN AVENUE, SUITE 3800, MILWAUKEE, WI, 53202-5308, US

(73) Assignee: Infowave Software, Inc.

(21) Appl. No.: 10/074,625

(22) Filed: Feb. 13, 2002

(51) Int. Cl. G06F 15/16; H04L 9/32; G06F 12/14

(52) U.S. Cl. 709/227; 713/200

(57) ABSTRACT

The system and method herein involve obscuring or encrypting a user identification (ID) for use in a plain text, unencrypted authentication scheme, such as Digest, Basic, or NTLM authentication. An exemplary embodiment of the system and method involves the creation of an obscured username that can be communicated over a unsecure communication channel, such as, a wireless communication channel, without disclosing identification information to third parties. One way in which the obscured username is created is by encrypting a plain text username. Both the obscured username and plain text username are stored at the client such that the obscured username is communicated over unsecure channels when the user enters the plain text username. Thus, the obscuring process is transparent to the user.

### FIELD OF THE INVENTION

The present invention relates generally to computer communication methods and systems. Further, an exemplary embodiment of the present invention relates to a system for and method of protecting a username during authentication over a non-encrypted channel.

### BACKGROUND OF THE INVENTION

Communication using plain text, unencrypted authentication schemes, such as, Digest, Basic, or NTLM authentication can involve the transmission of a username or user identifier (ID) with no protection from interception or detection. The authentication specifications for such schemes requires that the username be communicated unaltered. As such, third parties intercepting the unaltered username can identify messages from a specific user. Specific individuals using a particular system can also be identified.

Heretofore, others have approached the problem of protecting usernames or user identifiers (ID) communicated during authentication by utilizing a secure channel to encrypt the entire authentication process. A secure channel adds to the communication overhead associated with the system. Further, encryption can increase the processing time associated with the authentication process. Accordingly, encrypting the entire authentication process is costly and inefficient.

Thus, there is a need for a system for and method of protecting a username during authentication over a non-encrypted channel. Further, there is a need for obscuring or encrypting a user identification (ID) for use in a plain text, unencrypted authentication scheme. Even further, there is a need to avoid having to encrypt the entire authentication process.

The teachings hereinbelow extend to those embodiments which fall within the scope of the appended claims, regardless of whether they accomplish one or more of the above-mentioned needs.

### SUMMARY OF THE INVENTION

The present invention relates to a system and method of protecting a username during authentication when communicated over a non-encrypted channel. The system can include the creation of an obscured username that is communicated over a unsecure communication channel, such as, a wireless communication channel, without disclosing identification information to third parties. One way in which the obscured username is created is by encrypting a plain text username. Both the obscured username and plain text username are stored at the client device such that the obscured username is communicated over unsecure channels when the user enters the plain text username. Thus, the obscuring process is transparent to the user.

An exemplary embodiment relates to a method of protecting a username during authentication. This method can include obtaining a plain text username over a secure communication channel, obtaining a server identifier for a server, obscuring the plain text username using the server identifier, and providing the obscured username and the plain text username to the server. Then, over a non-secure communication channel, the method includes communicating authentication information including the obscured username from a client.

Another exemplary embodiment relates to a username protection process including registering a user with a selected server by requesting and receiving a plain text user identifier, creating an obscure version of the plain text user identifier, and storing the plain text user identifier and the obscure version of the plain text user identifier on the selected server. The process also includes initiating a communication session between the user and the selected server by the communication of the obscure version of the plain text user identifier over a plain text communication channel.

Another exemplary embodiment relates to a system for protecting a username during authentication over a non-encrypted channel. This system can include a client device configured to communicate information over secure and unsecure communication channels and a server having stored therein a plain text user identifier communicated by the client device over a secure communication channel and an obscured user identifier corresponding to the plain text user identifier.

Other features and advantages of embodiments of the present invention will become apparent to those skilled in the art upon review of the following drawings, the detailed description, and the appended claims.

### BRIEF DESCRIPTION OF THE DRAWINGS

The invention is illustrated by way of example and not limitation using the FIGURES of the accompanying drawings, in which like references indicate similar elements and in which:

FIG. 1 is a general block diagram of a username protection system and method for a non-encrypted channel in accordance with an exemplary embodiment;

FIG. 2 is a flow diagram illustrating a method of protecting a username during authentication over a non-encrypted channel in accordance with an exemplary embodiment;

FIG. 3 is a flow diagram illustrating a method of registering an obscured username in accordance with an exemplary embodiment; and

FIG. 4 is a diagrammatic representation of a username protection system and method in accordance with an exemplary embodiment.

### DETAILED DESCRIPTION OF THE EXEMPLARY EMBODIMENTS

A username protection system and method for a non-encrypted channel are described herein. In the following description, for purposes of explanation, numerous specific details are set forth to provide a thorough understanding of exemplary embodiments of the invention. It will be evident, however, to one skilled in the art that the invention may be practiced without these specific details. In other instances, structures and devices are shown in diagram form to facilitate description of the exemplary embodiments.

In one embodiment, a computer system is used which has a processing unit or central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

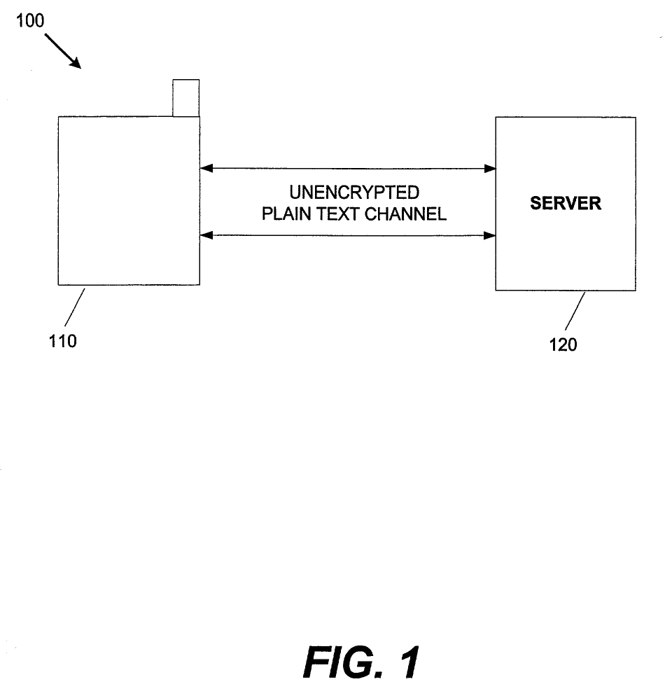

FIG. 1 illustrates a system 100 in which a client 110 communicates information to a wireless server 120. In one embodiment, client 110 and wireless server 120 are capable of communicating both encrypted and unencrypted data. In an alternative embodiment, client 110 communicates with wireless server 120 exclusively using a plain text, unencrypted channel. In such an embodiment, an encrypted username is set up before communication between client 110 and server 120, possibly by a different device.

Client 110 can be a wireless cellular digital phone (e.g., a WAP phone), a handheld personal digital assistant, a two-way text messaging device (e.g., two-way pager), a laptop computer, a handheld computer, a desktop computer, or any other device configured for communication over a network. Wireless server 120 can be a computer, computer server, or any other computing device coupled to a network for communication with client 110.

In an exemplary embodiment, client 110 can communicate an obscured or encrypted username to assure that it is unique and capable of duplication by either client 110 or server 120 using values known to both. An obscured or encrypted username is non-plain text and does not provide any real-world information to third parties.

Advantageously, an obscured or encrypted username can be utilized in a plain text, unencrypted authentication scheme, such as, Digest, Basic, or NTLM authentication. In an exemplary embodiment, the encryption of the username can be done with a key based on the uniform resource locator (URL) of server 120 or the authentication domain. Once encrypted, the username can be registered on server 120 with the existing, unencrypted username over a secure channel. The obscured username can be used over an unsecure channel without providing hints as to the real user.

Advantageously, the username protection process is completely transparent to users. Users believe that they are using a standard, plain text username. Both plain text and encrypted usernames are valid. However, only the encrypted username should be used over an unsecure channel. For example, a user logging into a web site using secure sockets layer (SSL) can enter a plain text username and can be authorized. A wireless client over an unencrypted, plain text channel, can use the encrypted username.

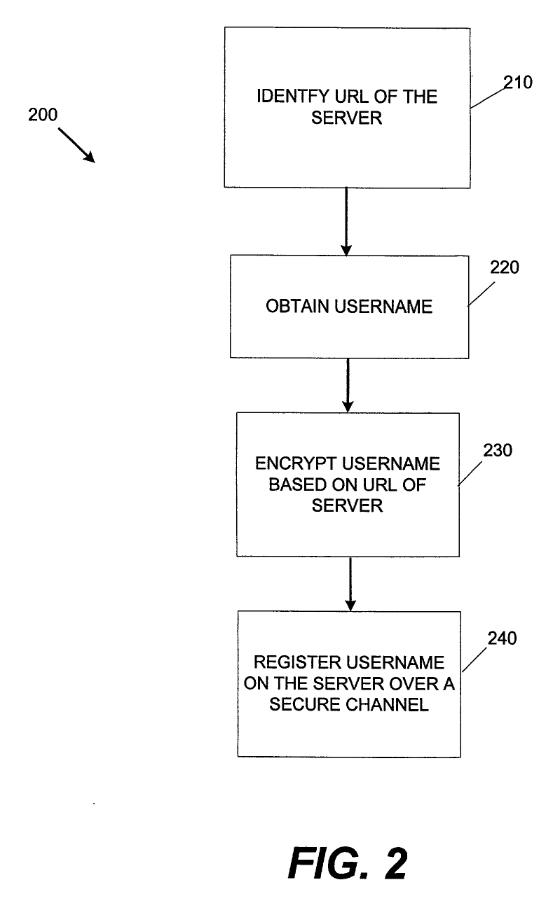

FIG. 2 illustrates a flow diagram 200 of a method of protecting a username during authentication over a non-encrypted channel. Flow diagram 200 illustrates by way of example some steps that may be performed. Additional steps, fewer steps, or combinations of steps may be utilized in various different embodiments.

In a step 210, a server URL is identified. Alternatively, the authentication domain can be used. In a step 220, a plain text username is obtained. A username can be entered using a limited text entry device, such as, a phone or other devices, such as, a personal digital assistant (PDA), laptop, or other communication device.

In a step 230, the username is encrypted or obscured based on the URL identified in step 210. That is, the encryption of the username can use the URL by generating a key based on the ASCII values of the characters of the URL. Additional ASCII values based on information, such as the server's realm or security domain, can also be used in the key generation process.

Different values may be used to obscure/encrypt the username. Furthermore, different algorithms can be used for encryption, such as MD5, SHA, DESX. The encryption process can also involve exchanging key information with a server. The generated key is used to encrypt the username. After encryption, the encrypted username is base 64 encoded (binary to text encoded).

Once the username is encrypted or obscured, a step 240 is performed in which the encrypted and non-encrypted username are registered or stored on the server using a secure channel.

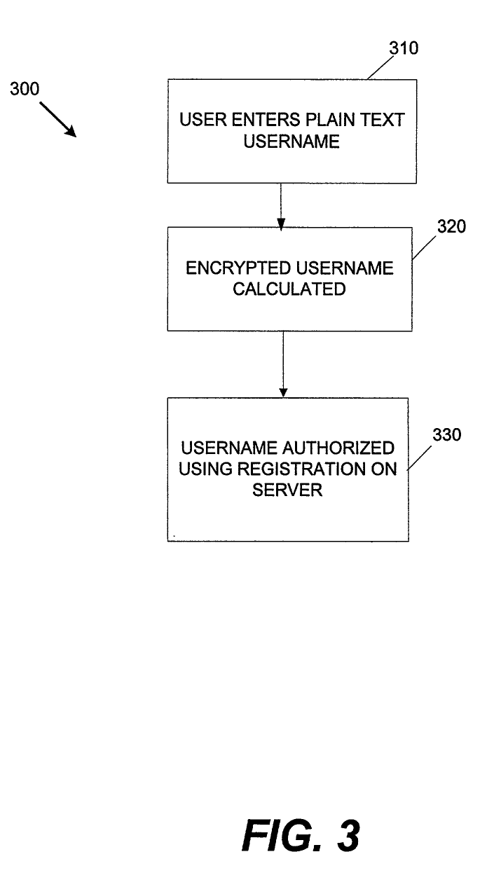

FIG. 3 illustrates a flow diagram 300 of a method of communicating using an obscured username. Flow diagram 300 illustrates by way of example some steps that may be performed. Additional steps, fewer steps, or combinations of steps may be utilized in various different embodiments.

In a step 310, a user enters a plain text username over a secure channel. The plain text username can be entered using a registration device or a client communication device. As such, entry of the plain text username does not necessarily need to be done with the same device used in communications with the server.

In a step 320, an encrypted username is calculated. The username is obscured or encrypted and registered on a server. Encryption can be done in a variety of ways using a variety of different types of information to make encryption keys. For example, domain information or URL information can be used to encrypt the username. Once the encrypted username is created, it is registered on the server with which the client device will communicate. In a step 330, the username is authorized using the registration on the server.

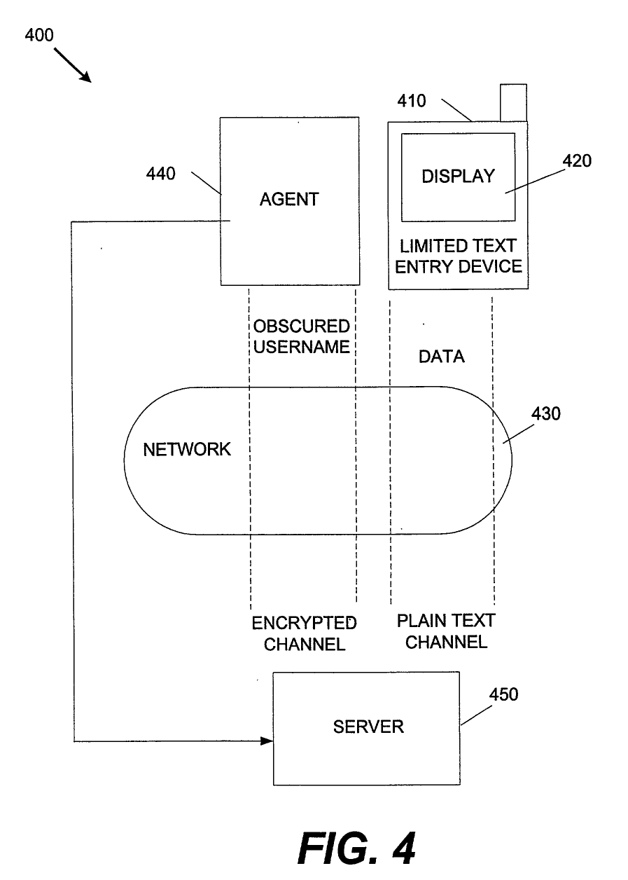

FIG. 4 illustrates a username protection system 400 including a device 410 having a display 420 and configured to communicate with a network 430. Device 410 can be a wireless cellular digital phone (e.g., a WAP phone), a handheld personal digital assistant, a two-way text messaging device (e.g., two-way pager), a laptop computer, a handheld computer, or any other such device.

In an exemplary embodiment, network 430 is a wireless network or the Internet, a worldwide network of computer networks that use various protocols to facilitate data transmission and exchange. Network 430 can use a protocol, such as, the TCP/IP network protocol or the DECnet, X.25, and UDP protocols. In alternative embodiments, network 430 is any type of network, such as, a virtual private network (VPN), an Internet, an Ethernet, or a Netware network. Further, network 430 can include a configuration, such as, a wireless network, a wide area network (WAN) or a local area network (LAN). Network 430 preferably provides communication with Hypertext Markup Language (HTML) Web pages.

Display 420 is configured to present textual and graphical representations. Display 420 can be a monochrome, black and white, or color display and can be configured to allow touch screen capabilities. Display 420 includes a limited real estate space for presenting information. Depending on the type of device 410, display 420 can have a wide variety of different dimensions. By way of example, display 420 is a WAP phone display having twelve horizontal lines of text capability. In alternative embodiments, display 420 can include more or fewer lines of text and graphics capability.

While it is possible that device 410 can be configured to communicate a username via an encrypted channel over network 430, a preferred embodiment involves a desktop agent 440 that is used to create, encrypt, and register a username with a server 450. Desktop agent 440 can communicate with server 450 over network 430 or via a direct connection. Data and other authentication information can be communicated from device 410 over network 430 via a plain text channel.

By way of example, using the systems and methods described in the FIGURES, a user enters a plain text username as “wince.” Using an encryption method, such as, advanced encryption standard (AES), the encryption parameters can be a combination of the authentication domain and the server URL: Realm(MyRealm)+URL(www.infowave.com\encryption). Encryption parameters are inputs used in the creation of encryption keys. ASCII values corresponding to textual information, such as URLs and domains, can be concatenated together to make large numbers. These large numbers can be used as encryption keys.

Once encrypted, a username can be encoded using a base of 64 (binary to text encoding). An example output from the encoding of an encrypted username is: Ljew872ks0JqQeoPmwe92==. As such, for authentication over a plain text channel “Ljew872ks0JqQeoPmwe92==” is used for the username instead of “wince”. If the user must supply the username, he or she can enter “wince” and the client application calculates the encrypted username. After receiving the encrypted username from the client, the server application can look up the unencrypted username.

Advantageously, the systems and methods described with reference to the FIGURES can register the user with an obscured username or ID, using a secure channel. Then, the obscured username can be utilized over a plain text channel. The obscured username provides higher security than if the obscured username were not used. If higher security were desired, the entire process would have to be encrypted, which could require too many resources for a wireless/thin client environment. If the obscured username were not registered with the server, then it would be necessary to depart from the standard authentication specifications for authentication specifications, such as, the Digest specification.

While the embodiments illustrated in the FIGURES and described above are presently preferred, it should be understood that these embodiments are offered by way of example only. Other embodiments may include additional procedures or steps not described here. The invention is not limited to a particular embodiment, but extends to various modifications, combinations, and permutations that nevertheless fall within the scope and spirit of the appended claims.

What is claimed is:

1. A method of protecting a username during authentication, the method comprising:
obtaining a plain text username over a secure communication channel;
obtaining a server identifier for a server;
obscuring the plain text username using the server identifier;
providing the obscured username and the plain text username to the server; and
communicating authentication information including the obscured username over a non-secure communication channel from a client.

2. The method of claim 17 wherein the server identifier is a uniform resource locator (URL) corresponding to the server.

3. The method of claim 1, wherein the server identifier is an authentication domain corresponding to the server.

4. The method of claim 1, wherein obscuring the plain text username using the server identifier comprises encrypting the plain text username using an encryption method.

5. The method of claim 17 wherein the encryption method is advanced encryption standard (AES).

6. The method of claim 1, wherein the client is a wireless device.

7. The method of claim 1, wherein obtaining a plain text username over a secure communication channel comprises establishing an encrypted communication session between the user and the server and communicating a plain text username from the user to the server.

8. The method of claim 1, wherein the authentication information satisfies a plain text, unencrypted authentication scheme.

9. The method of claim 1, wherein the server identifier is a combination of an authentication domain and a uniform resource locator (URL) of the server.

10. A username protection process comprising:
registering a user with a selected server by requesting and receiving a plain text user identifier, creating an obscure version of the plain text user identifier, and storing the plain text user identifier and the obscure version of the plain text user identifier on the selected server; and
initiating a communication session between the user and the selected server by the communication of the obscure version of the plain text user identifier over a plain text communication channel.

11. The process of claim 10, wherein the user is a wireless client device communicating over a non-encrypted channel.

12. The process of claim 10, wherein communication over a plain text channel involves the obscure version of the plain text user identifier and communication over a secure channel can use the plain text user identifier.

13. The process of claim 10, wherein the obscure version of the plain text user identifier is stored on the user device.

14. A system for protecting a username during authentication over a non-encrypted channel, system comprising:
a client device being configured to communicate information over unsecure communication channels; and
a server having stored therein a plain text user identifier communicated by the client device over a secure communication channel and an obscured user identifier corresponding to the plain text user identifier.

15. The system of claim 14, further comprising a registration device being configured to communicate information over secure communication channels.

16. The system of claim 15, wherein the client device and registration device are the same device.

17. The system of claim 14, wherein the client device does not encrypt communication when communicating with the obscured user identifier created from the plain text user identifier.

18. The system of claim 14, wherein the client device has stored therein the plain text user identifier and the obscured user identifier.

19. The system of claim 14, wherein the obscured user identifier corresponding to the plain text user identifier is created by encrypting the plain text user identifier with a key.

20. The system of claim 19, wherein the key is based on the uniform resource locator (URL) of the server or an authentication domain of the server.
